(19) United States
(12) Patent Application Publication
(10) Pub. No.: US 2024/0006729 A1
(43) Pub. Date: Jan. 4, 2024

(54) ELECTRODE STACK AND METHOD OF MANUFACTURING SAME

(71) Applicants: Hyundai Motor Company, Seoul (KR); Kia Corporation, Seoul (KR)

(72) Inventor: Jin Ho Ban, Suwon-Si (KR)

(21) Appl. No.: 18/076,714

(22) Filed: Dec. 7, 2022

(30) Foreign Application Priority Data
Jun. 29, 2022 (KR) 10-2022-0079349

(51) Int. Cl. H01M 50/54; H01M 50/536; H01M 10/04

(52) U.S. Cl. CPC H01M 50/54; H01M 10/04; H01M 50/536

(57) ABSTRACT

An electrode stack and a method of manufacturing the same are proposed. The electrode stack may include an A-type electrode including an A-type tab, and a B-type electrode stacked on the A-type electrode and including a B-type tab. The A-type tab and the B-type tab may not overlap each other, and the A-type electrode and the B-type electrode may have the same polarity.

### CROSS REFERENCE TO RELATED APPLICATION

The present application claims priority to Korean Patent Application No. 10-2022-0079349, filed Jun. 29, 2022, the entire contents of which are incorporated herein for all purposes by this reference.

### BACKGROUND

### Field

The present disclosure relates to an electrode stack and a method of manufacturing the same. More particularly, the present disclosure relates to an electrode stack of a secondary battery and a method of manufacturing the same.

### Description of the Related Art

A secondary battery is used as a rechargeable battery in various industrial fields, such as an electronic product or an electric vehicle. In particular, as the electric vehicle market has grown in recent years, various types of research and development are being conducted on the design of high-capacity batteries.

A battery cell is a component of the secondary battery. A cell assembly may be manufactured by stacking electrodes including a negative electrode and a positive electrode, a separator, and an electrolyte. The cell assembly may be sealed in a packing material, and a lead terminal may be connected to an electrode tab, thus completing a unit cell. The lead terminal connected to the electrode tab places the cell in electrical communication with the outside of the cell.

In order for the battery cell to have a high energy density, the number of electrodes stacked in the cell may be increased. For example, if the number of the electrodes stacked in the cell increases, the energy density of the cell may increase. This may improve an electric vehicle's driving range, which is the maximum distance that the vehicle may travel on a full charge of the battery. For this reason, the number of stacked electrodes per cell has been increasing. Further, when the thickness of the lead terminal increases during the quick charging or discharging of the battery (e.g., C-rate is 1 or higher), the amount of generated heat may be reduced. The demand for such high energy density and the demand for reducing the amount of generated heat during the quick charging are increasing the thickness of the electrode tab of the cell and a welding thickness between the electrode tab and the lead terminal.

However, when the welding thickness of the electrode tab or the welding thickness between the electrode tab and the lead terminal increases, several problems may occur. First, welding quality may be deteriorated. An increase in welding thickness may deteriorate the robustness of the weld and may cause a problem in welding quality, such as under-welding. Second, the production cost of the battery may increase and productivity may be deteriorated. As the welding thickness increases, the maintenance cycle of a welding tool is inevitably shortened. For example, in case of ultrasonic welding, the wear cycle or replacement cycle of consumables, such as a horn or an anvil, is shortened. In case of laser welding, the amount of foreign matter (spatter) scattered during welding increases. This increases a possibility that foreign matter enters a workpiece and should more frequently clean a jig that presses a welding portion.

Therefore, a method of securing weld robustness and preventing an increase in cost is required in spite of an increase in the welding thickness of the electrode tab.

### SUMMARY

Accordingly, the present disclosure has been made keeping in mind the above problems occurring in the related art, and an objective of the present disclosure is to provide an electrode stack and a method of manufacturing the same, capable of solving a problem caused by an increase in welding thickness between electrode tabs or between an electrode tab and a lead terminal in spite of an increase in tab-lead welding thickness.

Further, the present disclosure is to provide an electrode stack and a method of manufacturing the same, capable of securing weld robustness between an electrode tab and a lead terminal.

The present disclosure is not limited to the above-mentioned objective. Other objectives of the present disclosure will be clearly understood by those skilled in the art from the following description.

In order to achieve the objectives of the present disclosure and perform the characteristic function of the present disclosure that will be described later, the features of the present disclosure are as follows.

According to one or more embodiments of the present disclosure, an electrode stack may include an A-type electrode including an A-type tab; and a B-type electrode stacked on the A-type electrode and including a B-type tab. The A-type tab and the B-type tab may not overlap each other. The A-type electrode and the B-type electrode may have the same polarity.

According to one or more embodiments of the present disclosure, a method of manufacturing an electrode stack may include supplying an electrode sheet toward a processing machine; forming, via the processing machine, a plurality of electrode tabs on the electrode sheet and dividing the electrode sheet into a plurality of electrodes each having a predetermined size and having a respective electrode tab of the plurality of electrode tabs. The plurality of electrodes may include at least one A-type electrode and at least one B-type electrode. The at least one A-type electrode may include a first electrode tab at a first location relative to the at least one A-type electrode. The at least one B-type electrode may include a second electrode tab at a second location, different from the first location, relative to the at least one B-type electrode. The method may further include forming an electrode stack by sequentially stacking the plurality of.

The present disclosure provides an electrode stack and a method of manufacturing the same, capable of solving a problem caused by an increase in welding thickness between electrode tabs or between an electrode tab and a lead terminal in spite of an increase in welding thickness between the electrode tab and the lead terminal.

Further, the present disclosure provides an electrode stack and a method of manufacturing the same, capable of securing weld robustness between an electrode tab and a lead terminal.

Further, the present disclosure provides an electrode stack and a method of manufacturing the same, capable of preventing an increase in the production cost of a battery and a reduction in productivity.

The effects of the present disclosure are not limited to those described above, and other effects will be clearly recognized by those skilled in the art from the following description.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 illustrates an example process of manufacturing an electrode stack.

FIG. 2 is an example flowchart illustrating the process of FIG. 1.

FIG. 3 illustrates an example electrode stack.

FIG. 4 illustrates an example process of manufacturing an electrode stack.

FIG. 5 is a flowchart illustrating the example process of FIG. 4.

FIG. 6A illustrates an example state in which a negative electrode sheet is supplied to a processing machine while an electrode of the electrode stack.

FIG. 6B illustrates an example sequence of stacking the electrode processed by the processing machine as illustrated in FIG. 6A.

FIG. 6C is a flowchart illustrating an example method of manufacturing an electrode stack.

FIG. 7 illustrates a cross-section of an example electrode processing machine.

FIG. 8 illustrates a cross-section of an example general electrode processing machine.

FIG. 9 illustrates a stacking defect determination process during an example process of manufacturing the electrode stack.

FIG. 10 illustrates an example stacking defect determination method.

### DETAILED DESCRIPTION

Specific structural or functional descriptions set forth in the embodiments of the present disclosure are only for description of the embodiments of the present disclosure, and embodiments according to the concept of the present disclosure may be embodied in many different forms. The present disclosure should not be construed as being limited to only the embodiments set forth herein, but should be construed as covering all modifications, equivalents or alternatives falling within ideas and technical scopes of the present disclosure.

It will be understood that, although the terms “first,” “second,” etc. may be used herein to describe various elements, these elements should not be limited by these terms. These terms are only used to distinguish one element from another element. For instance, a first element discussed below could be termed a second element without departing from the teachings of the present disclosure. Similarly, the second element could also be termed the first element.

It will be understood that when an element is referred to as being “coupled” or “connected” to another element, it can be directly coupled or connected to the other element or intervening elements may be present therebetween. In contrast, it should be understood that when an element is referred to as being “directly coupled” or “directly connected” to another element, there are no intervening elements present. Other expressions that explain the relationship between elements, such as “between,” “directly between,” “adjacent to,” or directly adjacent to” should be construed in the same way.

Like reference numerals refer to like parts throughout various figures and embodiments of the present disclosure. The terminology used herein is for the purpose of describing particular embodiments only and is not intended to be limiting. In the present disclosure, the singular forms are intended to include the plural forms as well, unless the context clearly indicates otherwise. It will be further understood that the terms “comprise,” “include,” “have,” etc. when used in this specification, specify the presence of stated features, integers, steps, operations, elements, components, and/or combinations of them but do not preclude the presence or addition of one or more other features, integers, steps, operations, elements, components, and/or combinations thereof.

Hereinafter, the present disclosure will be described in detail with reference to the accompanying drawings.

As described above, recently, in order to improve the energy density of a battery cell, the number of electrodes stacked in one cell is increasing. As the number of the electrodes increases, the thickness of an electrode tab may also increase. This may increase the thickness of the welding (herein referred to as “pre-welding” or “preliminary welding”) between electrode tabs.

As for the charging speed of a battery, the thickness of a lead terminal also has been increasing to reduce the amount of heat generated during quick charging, which in turn results in increasing the thickness of the welding (herein referred to as “main welding”) between the electrode tab and the lead terminal.

Accordingly, the present disclosure is intended to address a problem that may occur due to an increase in welding thickness by changing the width of each electrode tab and the position of the electrode tab.

In the drawings, an electrode stack is made by stacking electrodes having the same polarity. All electrodes in the electrode stack may be either all positive electrodes or all negative electrodes. Thus, the present disclosure may be applied to either positive electrodes or negative electrodes. Further, a separator and the other electrode (e.g., if an electrode in the electrode stack is a negative electrode, the “other electrode” may refer to a positive electrode, and vice versa) of the cell are omitted in the drawings for the purpose of clarity and simplicity.

FIG. 1 illustrates an example process of manufacturing an electrode stack 10. Referring to FIG. 1, the electrode stack 10 may include a plurality of electrodes 11, and each electrode 11 may include an electrode tab 13 to be connected to an external circuit. Further, a lead terminal 15 may be connected to the electrode tab 13.

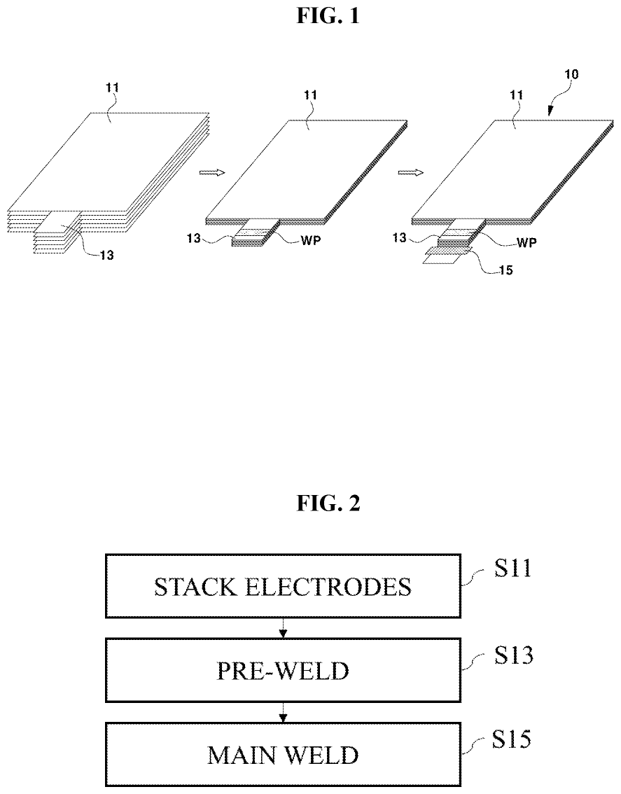

An example process of manufacturing the electrode stack 10 will be described with reference to FIG. 2. First, the plurality of electrodes 11 may be stacked at step S11. The number of the electrodes 11 included in the electrode stack 10 may be selected depending on a specified capacity of the battery.

Since the electrodes 11 are formed to have the same shape and size and include the electrode tabs 13 at the same position, the electrodes 11 may be stacked with the electrode tabs 13 overlapping each other. As such, at step S13, pre-welding may be performed between the electrode tabs 13 that are stacked and overlapping each other. For instance, a welding portion is denoted by the reference character WP. Further, each of the pre-welded electrode tabs 13 is welded to the lead terminal 15 in a main welding process, at step S15.

As such, the number of electrode tabs 13 to be welded together may coincide with the number of stacked electrodes 11. Therefore, as the number of the stacked electrodes 11 increases, the thickness of the weld between the electrode tabs 13 may increase.

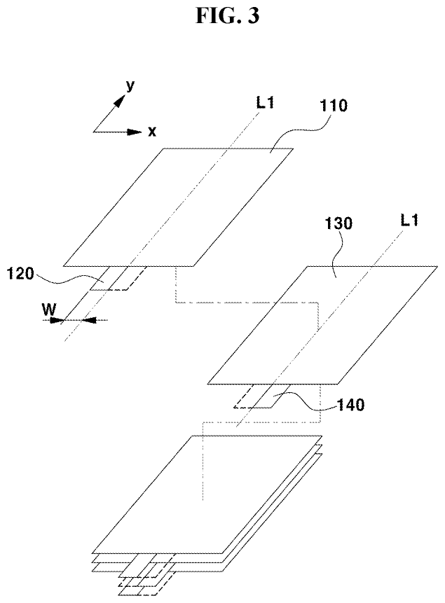

As shown in FIG. 3, the electrode stack according to the present disclosure may include two different types of electrodes 110, 130. The electrodes 110, 130 may have electrode tabs 120, 140 at different positions. Herein, in order to distinguish the two electrodes having the electrode tabs at different positions, one of the two electrodes will be referred to as an A-type electrode 110, and the other electrode will be referred to as a B-type electrode 130. An electrode tab of the A-type electrode 110 will be referred to as an A-type tab 120, and an electrode tab of the B-type electrode 130 will be referred to as a B-type tab 140. Further, x denotes the width direction of each electrode 110 or 130, and y denotes the longitudinal direction of each electrode 110 or 130.

For example, the A-type tab 120 of the A-type electrode 110 may be located on one side with respect to a central line L1 in the longitudinal direction y of the electrode 110 or 130, while the B-type tab 140 of the B-type electrode 130 may be located on the other side of the central line L1. In other words, the A-type electrode 110 and the B-type electrode 130 may be symmetrical to each other with respect to the central line L1.

Further, each of the A-type tab 120 and the B-type tab 140 may be formed to be smaller in width W than the electrode tab 13 of the conventional electrode 11. For example, the width W of the A-type tab 120 or the B-type tab 140 may be about half of that of the conventional electrode tab 11.

In the electrode stack 100, the A-type electrodes 110 and the B-type electrodes 130 may be alternately stacked. Therefore, the tabs of the electrodes stacked next to each other (e.g., consecutively) may be substantially configured not to overlap each other. In some embodiments, the A-type tab 120 and the B-type tab 140 in the electrode stack 100 may not overlap in the width direction x of the electrode 110 or 130. In some embodiments, the A-type tab 120 and the B-type tab 140 in the electrode stack 100 may not overlap at all while only edges thereof are aligned in the width direction x of the electrode 110 or 130. When the A-type tab 120 and the B-type tab 140 are arranged in this way, it may be possible to significantly reduce the thickness of the electrode tabs which overlap each other in the related art, without affecting the performance of the battery.

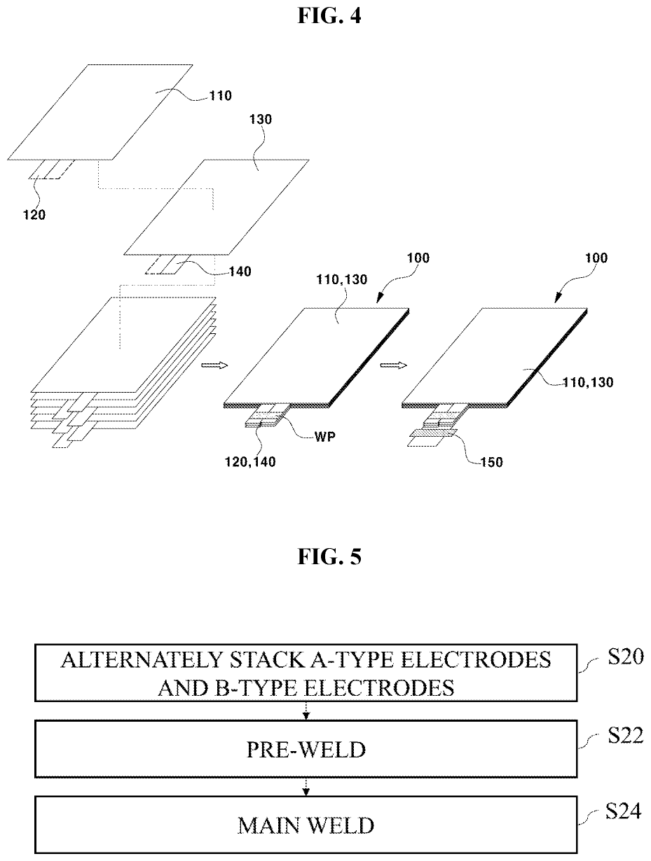

FIGS. 4 and 5 illustrate an example process of manufacturing the electrode stack 100 according to the present disclosure. The A-type electrodes 110 and the B-type electrodes 130 may be alternately stacked at step S20. In this case, the A-type electrode 110 may be located on the lowermost end of the electrode stack 100, or alternatively, the B-type electrode 130 may be located on the lowermost end of the electrode stack. Further, the A-type electrode 110 may be located on the uppermost end of the electrode stack 100, or alternatively the B-type electrode 130 may be located on the uppermost end of the electrode stack. For example, after the A-type electrode 110 is stacked and the B-type electrode 130 is stacked thereon, the A-type electrodes and the B-type electrodes may be alternately stacked, and stacking may be completed with the A-type electrode 110. Further, after the A-type electrode 110 is stacked and the B-type electrode 130 is stacked thereon, the A-type electrodes and the B-type electrodes may be alternately stacked, and stacking may be completed with the B-type electrode 130. Alternatively, after the B-type electrode 130 is stacked, the A-type electrodes 110 and the B-type electrodes may be alternately stacked, and stacking may be completed with the B-type electrode 130. Further, after the B-type electrode 130 is stacked, the A-type electrodes 110 and the B-type electrodes may be alternately stacked, and stacking may be completed with the A-type electrode 110. In order to maximize the effect of the present disclosure, a difference in number between the A-type electrodes 110 and the B-type electrodes 130 is preferably about one.

When a specified number of electrodes has been stacked, the A-type tabs 120 and the B-type tabs 140 may be subjected to a pre-welding process at step S22. The pre-welded A-type tabs 120 and B-type tabs 140 may be main welded to the lead terminal 150 at step S24, so that the electrode stack 100 may be completed.

As such, according to the present disclosure, the number of tabs to be welded relative to the number of stacked electrodes may be reduced by half. That is, according to the present disclosure, the welding thickness in the electrode stack can be significantly reduced.

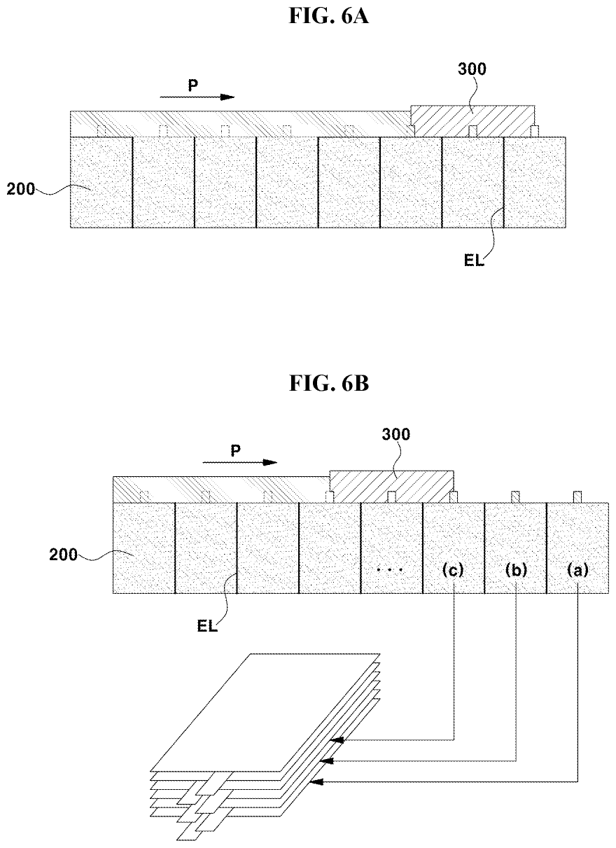

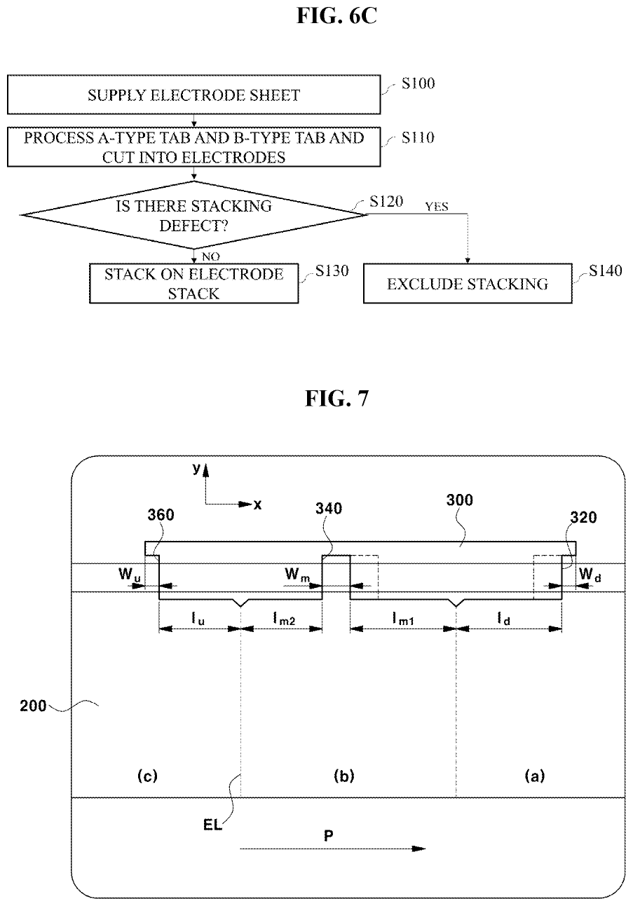

According to the present disclosure, the A-type electrode 110, the B-type electrode 130, and the electrode stack 100 may be manufactured through the following processes. This will be described with reference to FIGS. 6A to 6C.

As shown in FIG. 6A, a continuously formed electrode sheet 200 may be supplied toward a processing machine 300, at step S100. As a non-limiting example, the processing machine 300 may also be referred to as a blanking tool, a punching tool, a cutting tool, or the like. Further, the processing machine 300 may be a laser cutter. In this case, as in the processing machine 300 that will be described below, a cutting pattern program may be modified so that the processing of the electrode tab is performed.

Referring to FIG. 7, the processing machine 300 for manufacturing the A-type electrode 110 and the B-type electrode 130 may be provided.

The processing machine 300 may include three cut parts 320, 340, 360 to operate across at least three electrodes in one cutting operation. Specifically, the processing machine 300 may include a downstream cut part 320, a midstream cut part 340, and an upstream cut part 360. In this regard, the names of the cut parts 320, 340, 360 indicate the positions for the flow direction or travel direction P of the electrode sheet 200. At this time, the electrode sheet 200 may be cut into individual electrodes 110, 130 along an electrode line EL indicated on the electrode sheet 200, at step S110.

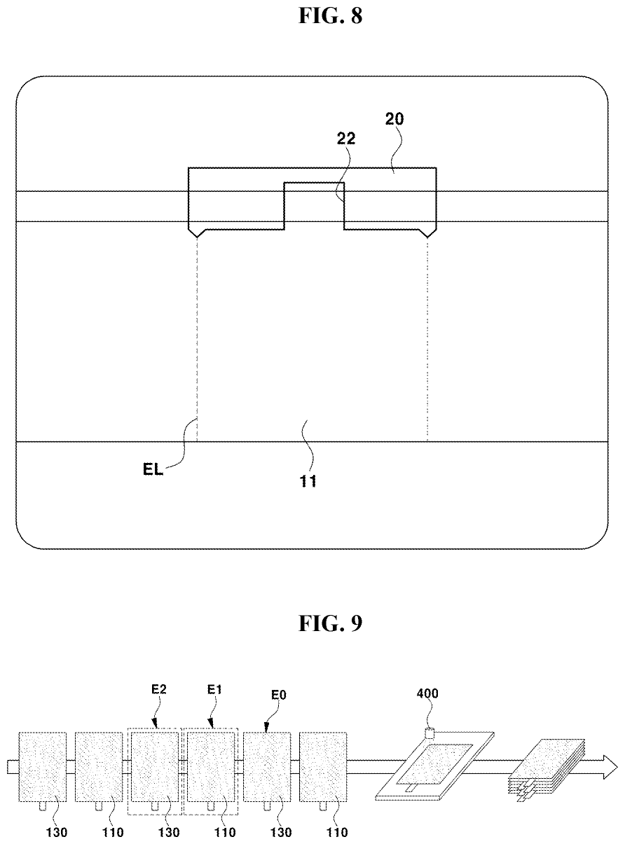

Since only one type of electrode 11 including the electrode tab 13 at the same position is required in the related art, the processing machine 20 may include a single cut part 22 so that only one electrode tab 13 is formed by one operation of the processing machine 20 (see FIG. 8). That is, the electrode 11 shown in FIG. 1 is manufactured by the processing machine 20 that forms the single electrode tab 13 as shown in FIG. 8.

On the other hand, since the present disclosure includes two types of electrodes (e.g., the A-type electrode 110 and the B-type electrode 130) to reduce the thickness of the electrode tabs that are to be welded, the processing machine 300 may include three cut parts 320, 340, 360. The same electrode, such as the A-type electrode 110, may be generated through the downstream cut part 320 and the upstream cut part 360, and a different type of electrode, such as the B-type electrode 130, may be generated through the midstream cut part 340. Alternatively, the B-type electrode 130 may be formed through the downstream cut part 320 and the upstream cut part 360, and the A-type electrode 110 may be formed through the midstream cut part 340. In other words, the downstream cut part 320 and the upstream cut part 360 may generate the same type of tabs arranged to overlap each other in the electrode stack 100 (e.g., the A-type tabs 120), and the midstream cut part 340 may generate different types of tabs that do not overlap the tabs generated by the downstream cut part 320 and the upstream cut part 360 in the electrode stack 100 (e.g., the B-type tabs 140).

The sum of a width wᵤ of the upstream cut part 360 and a width w_{d} of the downstream cut part 320 may be equal to a width wₘ in of the midstream cut part 340. The width wᵤ of the upstream cut part 360 and the width w_{d} of the downstream cut part 320 may be equal to or different from each other. The sum of the width wᵤ of the upstream cut part 360 and the width w_{d} of the downstream cut part 320 may be equal to the size of the electrode tab generated by the midstream cut part 340.

A distance between the midstream cut part 340 and the downstream cut part 320 and a distance between the midstream cut part 340 and the upstream cut part 360 may be formed to be different from each other. Thus, it may be possible to form two types of electrodes having the tabs at different positions. For example, an upstream width lₘ₂ of the midstream cut part 340 in an electrode (denoted by b) processed by the midstream cut part 340 may be smaller than a downstream width lₘ₁ thereof. Further, a downstream width lᵤ of the upstream cut part 360 in an electrode (denoted by c) processed by the upstream cut part 360 may be equal to the upstream width lₘ₂ of the electrode b processed by the midstream cut part 340. Further, an upstream width l_{d} of an electrode a processed by the downstream cut part 320 is equal to the downstream width lₘ₁ of the electrode b processed by the midstream cut part 340. Also, it is possible that the reverse will be the case. That is, the sum of the width lᵤ and the width lₘ₂ may be greater than the sum of the width lₘ₁ and the width l_{d}.

As shown in FIG. 7, when portions (a) to (c) of the electrode sheet (portion (a), portion (b), and portion (c) indicated on the electrode sheet 200 of FIG. 7 may also be referred to as a first portion, a second portion, and a third portion, respectively) or the electrodes (a) to (c) are located, the tab may be processed by the processing machine 300. Further, when the electrode sheet 200 moves so that the electrode c shifts to the position of the electrode (a) of FIG. 7, processing may be performed once again by the processing machine 300. Therefore, as for the electrode (c), half of the tab may be processed at position (c) and the other half of the tab may be processed at position (a).

Therefore, as shown in FIGS. 6B and 6C, the electrodes (a), (b), and (c) processed by the processing machine 300 may be sequentially stacked from the electrode (a) at the most downstream position in the travel direction P of the electrode sheet 200. Thus, if the most downstream electrode (a) is the A-type electrode 110, the B-type electrode 130 may be stacked thereon, and the A-type electrode 110 may be stacked thereon. The A-type electrode 110 and the B-type electrode 130 manufactured in this way may form the electrode stack.

As shown in FIG. 4, the stacked A-type tabs 120 and B-type tabs 140 may be welded through the pre-welding process. The A-type tab 120 may be welded to the A-type tab 120, and the B-type tab 120 may be welded to the B-type tab 120. Further, the lead terminal 150 may be main-welded thereto, so stacking is completed.

As described above, as the processing machine 300 operates on the moving electrode sheet 200, the manufactured electrodes may be sequentially stacked, and the electrode stack 100 may include two types of electrodes 110 and 130. If a defect occurs in any one of the electrodes 110, 130 that are alternately arranged as such, an error may occur in sequential stacking. For example, as shown in FIG. 9, if the A-type electrode 110 has a defect at position E1 and is removed from a line while the A-type electrodes 110 and the B-type electrodes 130 are sequentially manufactured, an error, in which the B-type electrode 130 at position E2 is stacked against the same type of electrode (e.g., B-type electrode 130) at position E0, may occur. If such an error occurs, the number of stacked A-type electrodes 110 may end up being different from that of B-type electrodes, and the benefit of reducing the number of tabs may decrease. Therefore, the present disclosure may further include a process of determining whether there is an error in the stacking order. Some embodiments of the present disclosure may further include an inspector 400 configured to determine whether there is a stacking defect in order to solve the problem noted above. For example, the stacking order defect may be determined through the inspection of the manufactured electrodes (e.g., via machine vision inspection).

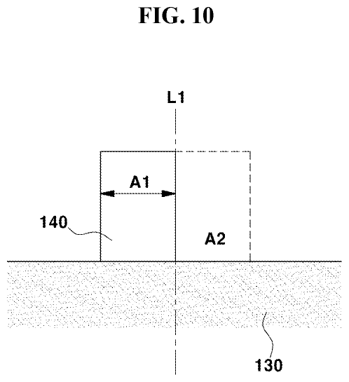

The inspector 400 may determine whether the electrode is correct by visually measuring the length of an electrode tab portion, at step S120. For example, as shown in FIG. 10, this may be determined by detecting whether the tabs 120, 140 of a certain width or more are located on one side A1 with respect to the central line L1 of the longitudinal direction y of the electrodes 110, 130 and the tab of a certain width or more is not present on the other side A2.

If it is determined that there is no stacking defect according to the inspection result of the inspector 400, stacking may be performed on the stacked electrodes at step S130. If it is determined that there is a stacking defect, the electrode may not be stacked but is discharged at step S140.

According to the present disclosure, welding quality can be improved by reducing a welding thickness between electrode tabs or an electrode tab and a lead terminal, and an increase in production cost due to an increase in welding thickness can be avoided.

Although the present disclosure was described with reference to specific embodiments shown in the drawings, it is apparent to those skilled in the art that the present disclosure may be changed and modified in various ways without departing from the scope of the present disclosure, which is described in the following claims.

What is claimed is:

1. An electrode stack comprising:
an A-type electrode comprising an A-type tab; and
a B-type electrode stacked on the A-type electrode and comprising a B-type tab,
wherein the A-type tab and the B-type tab do not overlap each other, and
wherein the A-type electrode and the B-type electrode have a same polarity.

2. The electrode stack of claim 1, wherein edges of the A-type tab and the B-type tab are aligned with each other.

3. The electrode stack of claim 1, wherein the A-type electrode is a first A-type electrode and the B-type electrode is a first B-type electrode, and wherein the electrode stack further comprises:
a second A-type electrode disposed on the first B-type electrode; and
a second B-type electrode disposed on the second A-type electrode.

4. The electrode stack of claim 3, wherein the A-type tab is a first A-type tab, wherein the B-type tab is a first B-type tab, wherein the second A-type electrode comprises a second A-type tab, wherein the second B-type electrode comprises a second B-type tab, wherein the first A-type tab and the second A-type tab overlap each other in a stacking direction of the electrode stack, and wherein the first B-type tab and the second B-type tab overlap each other in the stacking direction.

5. The electrode stack of claim 3, wherein the A-type tab is a first A-type tab, wherein the B-type tab is a first B-type tab, wherein the second A-type electrode comprises a second A-type tab, wherein the second B-type electrode comprises a second B-type tab, wherein the first A-type tab and the second A-type tab are welded to each other, and wherein the first B-type tab and the second B-type tab are welded to each other.

6. The electrode stack of claim 5, further comprising:
a lead terminal welded to the welded first and second A-type tabs and to the welded first and second B-type tabs.

7. The electrode stack of claim 1, wherein the A-type electrode and the B-type electrode are both positive electrodes or both negative electrodes.

8. A method comprising:
supplying an electrode sheet toward a processing machine;
forming, via the processing machine, a plurality of electrode tabs on the electrode sheet and dividing the electrode sheet into a plurality of electrodes each having a predetermined size and having a respective electrode tab of the plurality of electrode tabs, wherein the plurality of electrodes comprise at least one A-type electrode and at least one B-type electrode, wherein the at least one A-type electrode comprises a first electrode tab at a first location relative to the at least one A-type electrode, and wherein the at least one B-type electrode comprises a second electrode tab at a second location, different from the first location, relative to the at least one B-type electrode; and
forming an electrode stack by sequentially stacking the plurality of electrodes.

9. The method of claim 8, wherein the dividing the electrode sheet into the plurality of electrodes occurs concurrently or nonsimultaneously with the forming the plurality of electrode tabs.

10. The method of claim 8, wherein the dividing the electrode sheet into the plurality of electrodes comprises alternately producing the at least one A-type electrode and the at least one B-type electrode, and wherein the sequentially stacking the plurality of electrodes comprises alternately stacking the at least one A-type electrode and the at least one B-type electrode.

11. The method of claim 10, further comprising, prior to the stacking the at least one A-type electrode and the at least one B-type electrode, determining whether a stacking order of the at least one A-type electrode and the at least one B-type electrode conforms to a predetermined stacking order.

12. The method of claim 11, wherein the determining whether the stacking order of the at least one A-type electrode and the at least one B-type electrode conforms to the predetermined stacking order is performed via visual inspection.

13. The method of claim 8, further comprising:
welding the plurality of electrode tabs of the sequentially stacked plurality of electrodes; and
welding the plurality of electrode tabs to a lead terminal.

14. The method of claim 8, wherein the processing machine comprises a downstream cut part, a midstream cut part, and an upstream cut part configured to process the plurality of electrode tabs,
wherein the midstream cut part is located upstream with respect to the downstream cut part in a flow direction of the electrode sheet, and
wherein the upstream cut part is located upstream with respect to the midstream cut part in the flow direction of the electrode sheet.

15. The method of claim 14, wherein a sum of a width of the downstream cut part and a width of the upstream cut part is equal to a width of the midstream cut part.

16. The method of claim 15, wherein the width of the downstream cut part and the width of the upstream cut part are equal to each other.

17. The method of claim 14, wherein a distance between the downstream cut part and the midstream cut part is different from a distance between the midstream cut part and the upstream cut part.

18. The method of claim 17, wherein the distance between the downstream cut part and the midstream cut part is greater than the distance between the midstream cut part and the upstream cut part.

19. The method of claim 17, wherein the distance between the downstream cut part and the midstream cut part is less than the distance between the midstream cut part and the upstream cut part.

20. The method of claim 14, wherein the forming the plurality of electrode tabs comprises:
operating the processing machine after positioning:
a first portion of the electrode sheet in the downstream cut part,
a second portion, which extends from the first portion, of the electrode sheet in the midstream cut part, and
a third portion, which extends from the second portion, of the electrode sheet in the upstream cut part;
operating the processing machine after positioning the third portion in the downstream cut part.
